(19) United States
(12) Patent Application Publication
(10) Pub. No.: US 2016/0032166 A1
(43) Pub. Date: Feb. 4, 2016

(54) HOT-MELT ADHESIVE COMPOSITION AND METHOD FOR PREPARING THE SAME, HOT-MELT ADHESIVE THERMAL CONDUCTIVE SHEET AND METHOD FOR PREPARING THE SAME

(71) Applicant: ZHEJIANG SAINTYEAR ELECTRONIC TECHNOLOGIES CO., LTD., Zhejiang (CN)

(72) Inventors: Yuqiang ZHANG, Zhejiang (CN); Billy TIAN, Zhejiang (CN)

(21) Appl. No.: 14/424,973

(22) PCT Filed: Jan. 22, 2014
(86) PCT No.: PCT/CN2014/071094

§ 371 Date: Feb. 27, 2015

(51) Int. Cl. C09K 5/06; B29C 43/24; C09J 177/00; C09J 167/03; C09J 175/04

(52) U.S. Cl. CPC C09K 5/06; C09J 167/03; C09J 175/04; C09J 177/00; B29C 43/24; C08K 3/22

(57) ABSTRACT

The present invention provides a hot melt adhesive composition and a preparation method therefor, and a hot melt adhesive heat-conducting sheet and a preparation method therefor on a basis of the hot melt adhesive composition. The hot melt adhesive composition at least comprises: 6 to 9 parts of thermoplastic resin, 0.40 to 0.60 parts of tackifier, and 73 to 110 parts of heat-conducting particles by weight, the softening point of the thermoplastic resin ranging from 85 to 120 degrees centigrade. Because the softening point temperature of the thermoplastic resin is higher, the softening point temperature of the prepared hot melt adhesive composition is also higher, and accordingly, the heat-conducting sheet prepared by using the hot melt adhesive composition does not flow and deform in an ordinary temperature, thereby overcoming the defects of easily flowing and deforming in the prior art; in addition, the heat-conducting sheet provided in the present invention has a smaller thickness, thereby improving heat-conducting performance of the heat-conducting sheet.

### FIELD OF THE INVENTION

The present invention relates to the field of interface materials of electronic components, and in particular to a hot-melt adhesive composition and a method for preparing the same, as well as a thermal conductive sheet made from the hot-melt adhesive composition and a method for preparing the thermal conductive sheet.

### BACKGROUND OF THE INVENTION

Among types of the interface materials, a phase-change material is increasingly favored by professional designers as a material with superior properties such as high heat transfer efficiency, long service life, etc. Specifically, this phase-change interface material possesses a very low thermal resistance and a much longer life compared to silicone grease, and is more capable of being die cut into products meeting diverse demands for users as needed compare to a silicon mud product. The phase-change material has a feature that when the environmental temperature reaches the phase change point, it begins to soften and flow. As a general phase-change material of the interface material of the electronic component, its phase change point should not be too high, generally at around 50° C. This property gives a fatal defect during the application of this material, particularly the ocean shipping of the phase-change interface material, during which the environmental temperature often exceeds its phase change point, thus resulting in that the phase-change interface material has already begun to flow and deform before reaching the users. However, due to the superior properties of this phase-change interface material, it is highly expected by the market how to overcome the property easy to flow and also maintain the superior properties of the phasechange interface material.

### SUMMARY OF THE INVENTION

To this end, the first aspect of the present invention provides a hot-melt adhesive composition, a thermal conductive sheet prepared from the hot-melt adhesive composition will not flow and deform at the environmental temperature using the same.

Based on the first aspect of the present invention, the second aspect of the present invention further provides a method for preparing the hot-melt adhesive composition.

Based on the first aspect of the present invention, the third aspect of the present invention further provides a thermal conductive sheet made from the hot-melt adhesive composition.

Based on the third aspect of the present invention, the fourth aspect of the present invention further provides a method for preparing the hot-melt adhesive thermal conductive sheet.

In order to address the foregoing technical problems, the present invention adopts the technical solutions as follows:

A hot-melt adhesive composition, at least comprising:

6-9 parts by weight of a thermoplastic resin, which thermoplastic resin has a softening point between 85 and 120° C.;

0.40-0.60 parts by weight of a tackifier;

73-110 parts by weight of thermal conductive particles.

Optionally, the thermal conductive particles comprise:

20-30 parts by weight of thermal conductive particles with a particle size of 0.1-0.5 micrometers;

10-20 parts by weight of thermal conductive particles with a particle size of 3-5 micrometers,

28-35 parts by weight of thermal conductive particles with a particle size of 20-30 micrometers,

15-25 parts by weight of thermal conductive particles with a particle size of 3-10 micrometers.

Optionally, the thermal conductive particles with a particle size of 0.1-0.5 micrometers and/or the thermal conductive particles with a particle size of 3-5 micrometers are zinc oxide powder.

Optionally, the thermal conductive particles with a particle size of 20-30 micrometers and/or the thermal conductive particles with a particle size of 3-10 micrometers are aluminum powder.

Optionally, the thermoplastic resin includes at least one of PET, PA, PU, EVA, ABS, silicon resin and epoxy resin.

Optionally, the tackifier includes polyisobutylene and/or polybutylene.

A method for preparing the hot-melt adhesive composition as described above, comprising,

mixing predetermined parts by weight of a thermoplastic resin and a tackifier at a temperature condition higher than the softening point of the thermoplastic resin for a first predetermined period of time, to form a uniform molten mixture;

adding predetermined parts by weight of thermal conductive particles with various particle sizes into the molten mixture, and mixing at a temperature condition higher than the softening point of the thermoplastic resin for a second predetermined period of time, to allow the thermal conductive particles to disperse uniformly in the molten mixture, forming a hot-melt adhesive composition.

Optionally, the predetermined parts by weight of thermal conductive particles comprise:

20-30 parts by weight of thermal conductive particles with a particle size of 0.1-0.5 micrometers;

10-20 parts by weight of thermal conductive particles with a particle size of 3-5 micrometers,

28-35 parts by weight of thermal conductive particles with a particle size of 20-30 micrometers,

15-25 parts by weight of thermal conductive particles with a particle size of 3-10 micrometers.

Optionally, the thermal conductive particles with a particle size of 0.1-0.5 micrometers, the thermal conductive particles with a particle size of 3-5 micrometers, the thermal conductive particles with a particle size of 20-30 micrometers and the thermal conductive particles with a particle size of 3-10 micrometers are successively added into the molten mixture; and after the pre-added thermal conductive particles are dispersed uniformly in the molten mixture, other thermal conductive particles are successively added into the molten mixture.

Optionally, the thermal conductive particles are aluminum powder; and after the aluminum powder is added into the molten mixture, the molten mixture is stirred under the protection of an inert gas, to allow the thermal conductive particles to disperse uniformly in the molten mixture.

Optionally, the thermal conductive particles with a particle size of 20-30 micrometers and/or the thermal conductive particles with a particle size of 3-10 micrometers are aluminum powder; and after the aluminum powder is added into the molten mixture, the molten mixture is stirred under the protection of an inert gas, to allow the thermal conductive particles to disperse uniformly in the molten mixture.

A hot-melt adhesive thermal conductive sheet, which is made from the hot-melt adhesive composition as described in any one of the above items.

Optionally, the hot-melt adhesive thermal conductive sheet has a thickness less than 0.1 mm.

A method for preparing a hot-melt adhesive thermal conductive sheet as described above, comprising:

preparing a hot-melt adhesive composition according to the method for preparing a hot-melt adhesive composition as described in any one of the above items;

blending the hot-melt adhesive composition to form a glue sheet, and placing the formed glue sheet under a predetermined temperature condition for storage, with the predetermined temperature condition being capable of keeping the hot-melt adhesive composition in a softening state;

processing the formed glue sheet to form a thermal conductive sheet with a predetermined thickness;

cooling molding the formed thermal conductive sheet with the predetermined thickness.

Optionally, the formed glue sheet is calendered with a calender to form a thermal conductive sheet with a predetermined thickness.

Optionally, the roller temperature of the calender is controlled within the range of 110±5° C.

The thermoplastic resin in the hot-melt adhesive composition provided in examples of the present invention has a larger molecular chain and a higher softening point temperature, which is usually within a range of 85 to 120° C. Therefore, the hot-melt adhesive thermal conductive sheet made from this hot-melt adhesive composition also has a higher softening point, making the hot-melt adhesive thermal conductive sheet not flow and deform under a circumstance of 100° C., which overcomes defects that the phase-change interface material tends to flow at the temperatures commonly using the same.

### DESCRIPTION OF THE DRAWINGS

FIG. 1 is a flow chart of the method for preparing the hot-melt adhesive composition in an example of the present invention;

FIG. 2 is a flow chart of the method for preparing the hot-melt adhesive thermal conductive sheet in an example of the present invention.

### DETAILED EMBODIMENTS

In order to make the objectives, technical solutions and advantages of the examples of the present invention more clear, the technical solutions in the examples of the present invention will be clearly and completely described as follows; obviously, the described examples are some examples of the present invention, but not all the examples thereof. Based on the examples of the present invention, all the other examples obtained by those skilled in the art without any creative work fall within the protection scope of the present invention.

Firstly, specific embodiments of hot-melt adhesive compositions provided by the examples of the present invention are described.

Hot-melt adhesive compositions provide by examples of the present invention have the basic composition and the parts by weight of each composition as shown in the table below:

TABLE 1
Table of the basic composition of the hot-melt adhesive composition
provided by the examples of the present invention

| Composition | Parts by weight |
|---|---|
| Thermoplastic resin | 6-9 |
| Tackifier | 0.4-0.6 |
| Thermal conductive particles | 73-110 |

It is to be noted that, in order to avoid the flowing and deformation of the hot-melt adhesive thermal conductive sheet prepared from the hot-melt adhesive composition at a lower temperature, the thermoplastic resin as described in the examples of the present invention has a larger molecular chain, with its softening point within a range of 85˜120° C.

The thermoplastic resin in the hot-melt adhesive composition provided in the examples of the present invention may be single-component or multi-component. More specifically, the thermoplastic resin described in the examples of the present invention may include at least one of PET, PU, EVA, ABS, silicon resin and epoxy resin. More specifically, to allow the hot-melt adhesive thermal conductive sheet to have a higher tensile strength and tear strength, a multi-component thermoplastic resin is usually used, and it usually has PET, PU, PA or ABS as a matrix resin, and EVA as an auxiliary resin. Due to a lower softening temperature and an excellent flexibility of the EVA resin, the hot-melt adhesive composition made with EVA as the auxiliary resin has a higher strength. In addition, the thermoplastic resin described in the examples of the present invention may be solid hot-melt adhesive particles, and may also be a liquid glue.

The tackifier described in the examples of the present invention may improve the self-adhesive property of the hot-melt adhesive composition, enhance the compatibility between the thermoplastic resin and the thermal conductive particles; and the tackifier used in the examples of the present invention enables to be compatible with the hot-melt adhesive composition system, making the thermal conductive sheet prepared from the hot-melt adhesive composition not flow below 100° C. As the tackifier described in the examples of the present invention, polyisobutene and highly reactive polybutene products sold on the market, such as a tackifier from DAELIM Corporation, Korea, under a trade name of Polybutene, may be used.

In order to improve the thermal conductivity of the hot-melt adhesive composition, in the examples of the present invention, thermal conductive particles with a good thermal conducting property are selected. The thermal conductive particles provided in the examples of the present invention, in addition to having a thermal conducting effect, will improve the strength of the hot-melt adhesive composition as fillers of the hot-melt adhesive composition. Therefore, it is required for the particle sizes of the thermal conductive particles to have a proper distribution, to allow both a better thermal conductivity and strength of the hot-melt adhesive composition. Based on the close packing principle, the larger packing density the thermal conductive particles formulated with particles with different particle size distributions have, the higher thermal conducting property and strength the hot-melt adhesive composition will have. Through experimental verification, the thermal conductive particles preferably used in the examples of the present invention are formulated with thermal conductive particles with several different particle sizes:

TABLE 2
Formulation table of the thermal conductive particles

| Particle size (micrometer) | Parts by weight |
|---|---|
| 0.1-0.5 | 20-30 |
| 3-5 | 10-20 |
| 20-30 | 28-35 |
| 3-10 | 15-25 |

The thermal conductive particles described in the examples of the present invention may be one or more of zinc oxide powder, aluminum powder, aluminum oxide powder, aluminum nitride powder and boron nitride powder. Further, due to a good thermal conducting property of the aluminum powder, in order to improve the thermal conductivity of the hot-melt adhesive composition, all the thermal conductive particles employed may preferably be aluminum powder. However, generally, the compounding of aluminum powder with other types of thermal conductive particles may allow better properties of the prepared material; and thus, the thermal conductive particles with smaller particle sizes employed may be other thermal conductive particles in addition to aluminum powder, such as zinc oxide powder.

As an alternative example of the present invention, as the thermal conductive particles with a particle size of 0.1-0.5 micrometers and/or the thermal conductive particles with a particle size of 3-5 micrometers, zinc oxide powder is selected; as the thermal conductive particles with a particle size of 3-10 micrometers, aluminum powder is selected; and as the thermal conductive particles with a particle size of 20-30 micrometers, aluminum powder is selected.

Specifically, the formulation of such thermal conductive particles may be formulated with the parts by weight as shown in table 3.

TABLE 3
Parts by weight of the formulation of the thermal conductive particles

| Type of the thermal | | |
|---|---|---|
| conductive particles | Particle size (micrometer) | Parts by weight |
| Zinc oxide powder | 0.1-0.5 | 20-30 |
| Zinc oxide powder | 3-5 | 10-20 |
| Aluminum powder | 20-30 | 28-35 |
| Aluminum powder | 3-10 | 15-25 |

The thermal conductive particles formulated with the ratio shown in table 3 allow the hot-melt adhesive composition to have a coefficient of thermal conductivity reaching up to 4 W/m.k. Moreover, the coefficient of thermal conductivity of the hot-melt adhesive composition may be adjusted by adjusting the weight ratio of the thermoplastic resin to the thermal conductive particles for formulation; and further, the coefficient of thermal conductivity may reach up to any value below 4 W/m.k by adjusting the weight ratio.

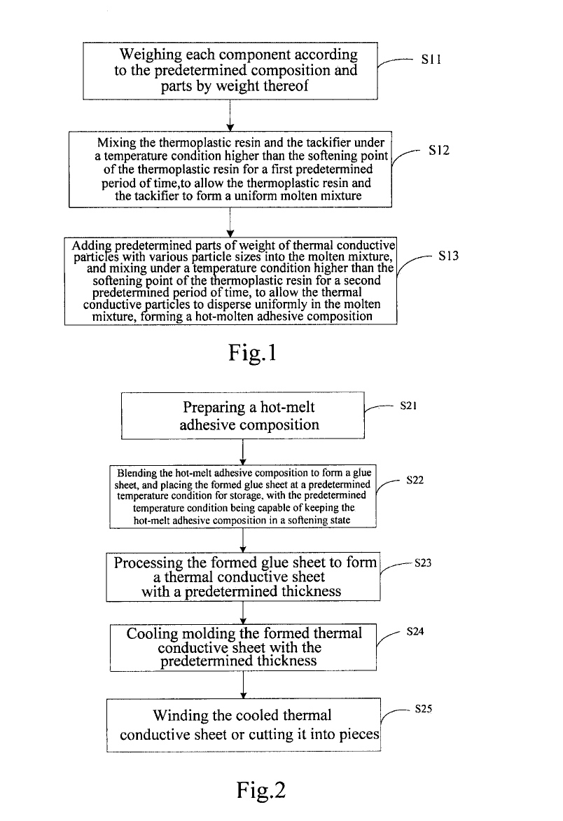

In an example of the present invention, there is provided a method for preparing the hot-melt adhesive composition as described above. As shown in FIG. 1, the method for preparing the hot-melt adhesive composition as described above comprises the follow steps.

S11. Each component is weighed according to the predetermined composition and parts by weight thereof.

Specifically, each component may be weighed according to the composition and parts by weight thereof as shown in table 1.

S12. The thermoplastic resin and the tackifier are mixed under a temperature condition higher than the softening point of the thermoplastic resin for a first predetermined period of time, to allow the thermoplastic resin and the tackifier to form a uniform molten mixture.

It is to be noted that, a temperature higher than the softening point of the thermoplastic resin cannot rise without limitation, to ensure that the thermoplastic resin and the tackifier can be molten, and that a thermal decomposition reaction will not occur for the thermoplastic resin and the tackifier at this temperature. The temperature while mixing varies based on the selected type of the thermoplastic resin, in which when the selected thermoplastic resin has a high softening point, the temperature while mixing will be high, and when it has a low softening point, the temperature while mixing will be low. Generally, when at least one of PET, PU, EVA, ABS, silicon resin and epoxy resin is used as the thermoplastic resin, the temperature used while mixing is generally within a range of 130±5° C. to meet the requirements.

Further, in the examples of the present invention, with the properties of the thermoplastic resin, it is heated to molten, and the tackifier is uniformly dispersed in the molten thermoplastic resin by way of stirring, to form a molten mixture. When mixing them by stirring, the mixing temperature may be determined in accordance with the molten viscosity of the thermoplastic resin. Since the molten viscosity index is decreased with the increasing temperature, generally, the temperature used during the mixing by stirring is between 130±5° C.

In addition, theoretically, the longer the first predetermined period of time is, the more uniform the mixing will be; however, a longer time will lead to reduced production efficiency. Therefore, as long as the mixing uniformity of the thermoplastic resin and the tackifier meets the predetermined requirement, the stirring may be stopped, to proceed to the next procedure. Through experimental validation, the first predetermined period of time has a time not less than 20 min, preferable of around 25 min.

S13. Predetermined parts of weight of thermal conductive particles with various particle sizes are added into the molten mixture, and mixed under a temperature condition higher than the softening point of the thermoplastic resin for a second predetermined period of time, to allow the thermal conductive particles to disperse uniformly in the molten mixture, forming a hot-molten adhesive composition.

For that thermal conductive particles of different particle sizes at predetermined parts by weight are added into the molten mixture formed in the step S12, in order to disperse the thermal conductive particles uniformly in the molten mixture to form a hot-molten adhesive composition, the molten mixture is mixed with stirring under a temperature condition higher than the softening point of the thermoplastic resin; and moreover, for the convenience of achieving the process, the temperature while mixing by stirring in this step is generally 10° C. or more higher than the softening point, preferably 30° C. or more higher.

The period of time for mixing by stirring in this step is the second predetermined period of time. In consideration of the equilibrium between the mixing uniformity and the production efficiency, this predetermined period of time is preferably around 130 min.

It is to be noted that, as described above, the thermal conductive particles described in the examples of the present invention may include thermal conductive particles with a plurality of different particle size distributions. When the thermal conductive particles selected in the examples of the present invention include a condition with a temperature higher than the softening point of the thermoplastic resin, the thermal conductive particles with different particle size distributions may be added into the molten mixed solution simultaneously. However, in order to disperse the thermal conductive particles uniformly in the hot-molten adhesive composition, the thermal conductive particles with different particle size distributions may be added into the molten mixture in a step-wise way, in which specifically, after the thermal conductive particles added previously are dispersed uniformly in the molten mixture, thermal conductive particles with other particle size distributions may be added then into the molten mixture.

In the examples of the present invention, when the thermal conductive particles as shown in table 3 are used, the sequence for adding the thermal conductive particles with different particle size distributions may be as follows.

Firstly, 20-30 parts by weight of zinc oxide powder with a particle size of 0.1-0.5 micrometers are added, and stirred to allow them to be mixed uniformly in the molten mixture, with a stirring time preferably 20 min or more, further preferably of around 25 min.

Thereafter, 10-20 parts by weight of zinc oxide powder with a particle size of 3-5 micrometers are added, and stirred to allow the zinc oxide powder to be mixed uniformly in the molten mixture, with a stirring time preferably 20 min or more, further preferably of around 25 min.

And then, 28-35 parts by weight of aluminum powder with a particle size of 20-30 micrometers are added, and under a protection of an inert gas such as nitrogen gas, stirred to allow them to disperse uniformly, with a stirring time preferably 40 min or more.

Finally, 15-25 parts by weight of aluminum powder with a particle size of 3-10 micrometers are added into the above molten mixture, and continuously stirred under a protection of an inert gas such as nitrogen gas to allow them to disperse uniformly, with a stirring time preferably 40 min or more. After the thermal conductive particles are dispersed uniformly in the molten mixture, the nitrogen gas is released, to prepare a hot-melt adhesive composition.

The prepared hot-melt adhesive composition is placed at a high temperature for storage to wait for subsequent use. It is to be noted that, the high temperature enables to maintain the hot-melt adhesive composition in a softening state or a molten state, for example, which may be stored at a temperature in a range of 130±5° C.

In addition, when the aluminum powder is added and stirred as described above, preferably an inert gas is bubbled into the stirring system, which is because the aluminum powder is readily oxidized by the oxygen gas in air, and in order to prevent the oxidization reaction of the aluminum powder with oxygen gas, it is necessary to bubble an inert gas into the stirring system to isolate the air.

Further, a hot-melt adhesive thermal conductive sheet may be prepared using the hot-melt adhesive composition prepared as described above, and the hot-melt adhesive thermal conductive sheet may be used for an interface thermal conductive material in electronic components.

Due to the higher softening point temperature, which is between 85° C. to 120° C., of the thermoplastic resin in the hot-melt adhesive composition as described above, the hot-melt adhesive thermal conductive sheet prepared using the hot-melt adhesive composition as described above has a higher softening point temperature. The normal environmental temperatures for it to be used are all lower than the softening point temperature of the hot-melt adhesive thermal conductive sheet; therefore, the hot-melt adhesive thermal conductive sheet will not flow and deform at the normal environmental temperatures as used. In addition, in combination with the compatibilization of the tackifier, the compatibility between the thermoplastic resin and the thermal conductive particles is increased, and the hot-melt adhesive thermal conductive sheet is not easy to have a flowing and deformation phenomenon under the normal environmental temperature as used.

Moreover, because the thermal conductive particles in the above hot-melt adhesive thermal conductive sheet have relatively proper particle size distributions, in the hot-melt adhesive thermal conductive sheet, the thermoplastic resin has a better compatibility with the thermal conductive particles. Such a thermal conductive sheet possesses a good ability to contact the interface sufficiently at a normal temperature, even under a condition of 100° C. will not flow. Moreover, the hot-melt adhesive thermal conductive sheet prepared in the examples of the present invention may be made to be less than 0.1 millimeter, and may have a coefficient of thermal conductivity at most up to 4 W/m k, and can adapt to the requirement on the large-scale production.

An example of the present invention further provides a method for preparing the hot-melt adhesive thermal conductive sheet as described above. In conjunction with FIG. 2, the method for preparing the hot-melt adhesive thermal conductive sheet as described above is described. As shown in FIG. 2, the preparation method includes the following steps.

S21. Preparation of the hot-melt adhesive composition.

The hot-melt adhesive composition is prepared using the formation of method as described in the above example. The prepared hot-melt adhesive composition is placed at a high temperature for storage, to make the hot-melt adhesive composition in a molten state.

S22. The hot-melt adhesive composition is blended to form a glue sheet, and the formed glue sheet is placed at a predetermined temperature condition for storage, with the predetermined temperature condition being capable of keeping the hot-melt adhesive composition in a softening state.

The prepared hot-melt adhesive composition in a molten state is blended by using a blender (an open mill), during which the shear force between rollers of the blender enables the mixing uniformity of the hot-melt adhesive composition to have a further improvement, finally to blend the hot-melt adhesive composition into a glue sheet having a predetermined size. The glue sheet having the predetermined size may have a size of an A4 paper, and a thickness of around 1 millimeter. Thereafter, the glue sheet as blended well is placed at a predetermined temperature condition. The predetermined temperature condition allows the hot-melt composition to keep in a softening state. That is to say, this predetermined temperature is at least higher than the softening point temperature of the hot-melt adhesive composition. Generally, the prepared hot-melt adhesive composition has a softening point temperature lower than 100° C.; therefore, the hot-melt adhesive composition prepared in the examples of the present invention may be placed on a thermal insulation platform with a temperature of 100±5° C. for storage. The placed hot-melt adhesive composition keeping a softening state is advantageous to facilitate the next process operation.

S23. The formed glue sheet is processed to form a thermal conductive sheet with a predetermined thickness.

It is to be noted that, the hot-melt adhesive thermal conductive sheet in the examples of the present invention may be calendered by using a calender. The temperature used when calendaring may be at 110±5° C. The roller temperature of the calender is increased in advance to a predetermined temperature of 110±5° C. A release film is unwound through an air swelling shaft unwinding device, and pulled onto the calender as a lower protective film of the thermal conductive sheet; and then another release film as an upper protective film of the thermal conductive sheet is also pulled onto the calender. A prepared glue sheet is placed between the two release films, and the thickness of the thermal conductive sheet is controlled by adjusting the interval between rollers of the calender, thus making the calendaring molded thermal conductive sheet have a predetermined thickness. The use of the release films as protective films of the thermal conductive sheet enables to achieve a continuous production.

It is to be noted that, the release film used in the examples of the present invention may be a PET release film, and also may be a PE or OPP release film. The release film may have a thickness of for example 0.075 or 0.05 millimeter.

Adjustment of the intervals between the rollers of the calender enables the thickness of the calendered thermal conductive sheet to reach 0.1 millimeter or less. As compared to the thermal conductive sheet in the prior art, the thickness is significantly decreased, which is in favor of improving the coefficient of the thermal conductivity of the thermal conductive sheet.

S24. The formed thermal conductive sheet with the predetermined thickness is cooling molded.

The thermal conductive sheet calendered by the calender has a higher temperature, which is introduced through the pulling of the release film into a cooling zone to be cooling molded, thereby forming a thermal conductive sheet with a predetermined thickness. It is to be noted that, the cooling zone used in the examples of the present invention may be a zone with a length of 5 meters.

S25. The cooled thermal conductive sheet is wound or cut into pieces.

The above refers to the method for preparing a hot-melt adhesive thermal conductive sheet. The thermal conductive sheet prepared by the preparation method as described above has a coefficient of thermal conductivity significantly higher than that of the thermal conductive sheet in the prior art. Moreover, the prepared thermal conductive sheet has a thickness which may be reduced to around 0.1 mm, and a smaller thickness also favors the thermal dissipation of the thermal conductive sheet.

Three examples and one comparative example are cited below to further illustrate the embodiments of the present invention and the beneficial effects thereof.

### EXAMPLE 1

The hot-melt adhesive composition in example 1 had a composition and the parts by weight thereof as shown in table 4.

TABLE 4
Formulation of example 1

| | Weight |
|---|---|
| Composition | (unit: Kg) |
| PET resin | 2.5 |
| EVA resin | 5 |
| Tackifier | 0.5 |
| Zinc oxide powder with a particle size of 0.5 micrometers | 25 |
| Zinc oxide powder with a particle size of 5 micrometers | 15 |
| Aluminum powder with a particle size of 30 micrometers | 32 |
| Aluminum powder with a particle size of 4 micrometers | 20 |

The method for preparing the hot-melt adhesive thermal conductive sheet with the above composition was as follows:

A. Preparation of the hot-melt adhesive composition:

1) 2.5 kg of PET resins, 5 kg of EVA resin and 0.5 kg of a tackifier were weighed and mixed at 130±5° C. for 15 min to allow them to thoroughly mix uniformly;

25 kg of zinc oxide powder with a particle size of 0.5 micrometers was added, with continuously stirring for 25 min, to wait for mixing uniformly;

3) 15 kg of zinc oxide powder with a particle size of 5 micrometers was added, with continuously stirring for 25 min, to wait for mixing uniformly;

4) 32 kg of aluminum powder with a particle size of 30 micrometers was added and stirred under a protection of nitrogen gas for 40 min; and after stirring uniformly, 20 kg of aluminum powder with a particle size of 4 micrometers was added (with continuously keeping under an environmental condition of nitrogen gas protection) and stirred for 40 min; after stirring uniformly, the nitrogen gas was released, followed by thermal insulating storage under a condition of 130±5° C. for subsequent use.

It is to be noted that, the inert gas used in example 1 of the present invention was nitrogen gas, and of course, may also employ other inert gases such as argon gas and the like.

B. Press molding.

1) The high-temperature glue material prepared in the step A was milled with an open miller into a glue sheet with an A4 size and a thickness of 1 mm, and then stored at a thermal insulating platform of a temperature of 100±5° C. for thermal insulating storage. With raising the two-roller calender to 110±5° C., a PET release film of 0.075 mm thick was unwound through an air swelling shaft unwinding device and pulled onto the calender as a lower protective film of the product; and a PET release film of 0.05 mm thick was pulled onto the two-roller calender as an upper protective film of the product. And then a prepared glue sheet was placed between the two release film, and by adjusting the intervals between rollers in the calender, the product was controlled to a desired thickness (0.1 mm), thus to proceed continuous production.

2) Cooling: the calendered product was pulled with the release film into a cooling zone with a length of 5 m to be cooling molded, and after cooling, it was rolled/cut into pieces.

### EXAMPLE 2

The hot-melt adhesive composition in example 2 had a composition and parts by weight thereof as shown in table 5.

TABLE 5
Formulation of example 2

| | Weight |
|---|---|
| Composition | (unit: Kg) |
| PU resin | 3 |
| EVA resin | 6 |
| Tackifier | 0.5 |
| Zinc oxide powder with a particle size of 0.3 micrometers | 27 |
| Zinc oxide powder with a particle size of 4.5 micrometers | 18 |
| Aluminum powder with a particle size of 25 micrometers | 35 |
| Aluminum powder with a particle size of 5 micrometers | 20 |

The method for preparing the hot-melt adhesive thermal conductive sheet as described in example 2 was the same as the preparation method in example 1. For concise illustration, it will not be described in details, which specifically refers to the detailed illustration of example 1.

### EXAMPLE 3

The hot-melt adhesive composition in example 3 had a composition and parts by weight thereof as shown in table 6

TABLE 6
Formulation of example 3

| | Weight |
|---|---|
| Composition | (unit: Kg) |
| PA resin | 2.5 |
| EVA resin | 6 |
| Tackifier | 0.5 |
| Zinc oxide powder with a particle size of 0.3 micrometers | 25 |
| Zinc oxide powder with a particle size of 3 micrometers | 18 |
| Aluminum powder with a particle size of 20 micrometers | 30 |
| Aluminum powder with a particle size of 5 micrometers | 20 |

The method for preparing the hot-melt adhesive thermal conductive sheet as described in example 3 was the same as the preparation method in example 1. For concise illustration, it will not be described in details, which specifically refers to the detailed illustration of example 1.

The hot-melt adhesive thermal conductive sheet prepared with the formulations and processes as described in the above examples 1 to 3 had relative test parameters as sown in table 7:

TABLE 7
Comparison of test parameters of examples 1-3 with the comparative
example in the present invention

| | | Coefficient | Thermal | Tensile | Tear |
|---|---|---|---|---|---|
| | Thick- | of thermal | resistance | strength | strength |
| Test | ness | conductivity | (° C.-sq. | (%) | (psi) |
| parameters | (mm) | (W/m · k) | in/w@50 psi) | ASTM | ASTM |
| Test standard | / | Hot-disk | ASTM D5470 | D412 | D412 |
| EXAMPLE | 0.1 | 4.1 | 0.010 | 92 | 37 |
| 1 | | | | | |
| EXAMPLE | 0.1 | 3.8 | 0.011 | 87 | 39 |
| 2 | | | | | |
| EXAMPLE | 0.1 | 3.5 | 0.012 | 83 | 39 |
| 3 | | | | | |
| COM- | 0.13 | 2.8 | 0.020 | 85 | 32 |
| PARATIVE | | | | | |
| EXAMPLE | | | | | |

It can be seen from the test performances of the thermal conductive sheets as shown in table 7 that, the thermal conductive sheets prepared in examples 1-3 of the present invention have thicknesses less than that of the thermal conductive sheet in the comparative example. Moreover, the thermal conductive sheets prepared in examples 1-3 of the present invention have significantly higher coefficients of thermal conductivity, and significantly lower thermal resistances, as compared to that of the thermal conductive sheet in the comparative example.

It will be understood that, although the present invention has been described according to the embodiments, each of the embodiments does not only include one independent technical solution, of which the narrative way in the description is only for clarity. Those skilled in the art shall regard the description as a whole, wherein the technical solutions in each embodiment may be suitably combined to form other embodiments which can be understood by those skilled in the art.

A range of the detailed description outlined above is only directed to specifically illustrate the feasible embodiments of the present invention, which are not used to limit the protection scope of the present invention. The equivalent embodiments or modifications made without departing from the technical spirit of the present invention are all included within the protection scope of the present invention.

1. A hot-melt adhesive composition, characterized in that it at least comprises:
6-9 parts by weight of a thermoplastic resin, which thermoplastic resin has a softening point between 85 and 120° C.;
0.40-0.60 parts by weight of a tackifier;
73-110 parts by weight of thermal conductive particles.

2. The hot-melt adhesive composition according to claim 1, characterized in that the thermal conductive particles comprise:
20-30 parts by weight of thermal conductive particles with a particle size of 0.1-0.5 micrometers;
10-20 parts by weight of thermal conductive particles with a particle size of 3-5 micrometers,
28-35 parts by weight of thermal conductive particles with a particle size of 20-30 micrometers, 15-25 parts by weight of thermal conductive particles with a particle size of 3-10 micrometers.

3. The hot-melt adhesive composition according to claim 2, characterized in that the thermal conductive particles with a particle size of 0.1-0.5 micrometers and/or the thermal conductive particles with a particle size of 3-5 micrometers are zinc oxide powder.

4. The hot-melt adhesive composition according to claim 2, characterized in that the thermal conductive particles with a particle size of 20-30 micrometers and/or the thermal conductive particles with a particle size of 3-10 micrometers are aluminum powder.

5. The hot-melt adhesive composition according to claim 1, characterized in that the thermoplastic resin includes at least one of PET, PA, PU, EVA, ABS, silicon resin and epoxy resin.

6. The hot-melt adhesive composition according to claim 1, characterized in that the tackifier includes polyisobutylene and/or polybutylene.

7. The hot-melt adhesive composition according to claim 4, characterized in that the tackifier includes polyisobutylene and/or polybutylene.

8. A method for preparing a hot-melt adhesive composition according to claim 1, characterized in that the method comprises:
mixing predetermined parts by weight of a thermoplastic resin and a tackifier at a temperature condition higher than the softening point of the thermoplastic resin for a first predetermined period of time, to form a uniform molten mixture;
adding predetermined parts by weight of thermal conductive particles with various particle sizes into the molten mixture, and mixing at the temperature condition higher than the softening point of the thermoplastic resin for a second predetermined period of time, to allow the thermal conductive particles to disperse uniformly in the molten mixture, forming a hot-melt adhesive composition.

9. The method for preparing according to claim 8, characterized in that the predetermined parts by weight of the thermal conductive particles comprise:
20-30 parts by weight of thermal conductive particles with a particle size of 0.1-0.5 micrometers;
10-20 parts by weight of thermal conductive particles with a particle size of 3-5 micrometers,
28-35 parts by weight of thermal conductive particles with a particle size of 20-30 micrometers,
15-25 parts by weight of thermal conductive particles with a particle size of 3-10 micrometers.

10. The method for preparing according to claim 9, characterized in that the thermal conductive particles with a particle size of 0.1-0.5 micrometers, the thermal conductive particles with a particle size of 3-5 micrometers, the thermal conductive particles with a particle size of 20-30 micrometers and the thermal conductive particles with a particle size of 3-10 micrometers are successively added into the molten mixture; and after the pre-added thermal conductive particles are dispersed uniformly in the molten mixture, other thermal conductive particles are successively added into the molten mixture.

11. The method for preparing according to claim 8, characterized in that the thermal conductive particles are aluminum powder; and after the aluminum powder is added into the molten mixture, the molten mixture is stirred under the protection of an inert gas, to allow the thermal conductive particles to disperse uniformly in the molten mixture.

12. The method for preparing according to claim 9, characterized in that the thermal conductive particles with a particle size of 20-30 micrometers and/or the thermal conductive particles with a particle size of 3-10 micrometers are aluminum powder; and after the aluminum powder is added into the molten mixture, the molten mixture is stirred under the protection of an inert gas, to allow the aluminum powder to disperse uniformly in the molten mixture.

13. A hot-melt adhesive thermal conductive sheet, characterized in that the hot-melt adhesive thermal conductive sheet is made from a hot-melt adhesive composition according to claim 1.

14. The hot-melt adhesive thermal conductive sheet according to claim 13, characterized in that the hot-melt adhesive thermal conductive sheet has a thickness less than 0.1 mm.

15. A method for preparing the hot-melt adhesive thermal conductive sheet according to claim 13 or 14, characterized in that the method comprises:
preparing a hot-melt adhesive composition according to the method for preparing a hot-melt adhesive composition according to claim 8;
blending the hot-melt adhesive composition to form a glue sheet, and placing the formed glue sheet under a predetermined temperature condition for storage, with the predetermined temperature condition being capable of keeping the hot-melt adhesive composition in a softening state;
processing the formed glue sheet to form a thermal conductive sheet with a predetermined thickness;
cooling molding the formed thermal conductive sheet with the predetermined thickness.

16. The method for preparing according to claim 15, characterized in that the formed glue sheet is calendered with a calender to form a thermal conductive sheet with a predetermined thickness.

17. The method for preparing according to claim 16, characterized in that the roller temperature of the calender is controlled within a range of 110±5° C.
